(19) United States
(12) Patent Application Publication
(10) Pub. No.: US 2007/0269791 A1
(43) Pub. Date: Nov. 22, 2007

(54) Method of Preparing Isolated Cell-Free Skin, Cell-Free Dermal Matrix, Method of Producing the Same and Composite Cultured Skin with The Use of the Cell-Free Dermal Matrix

(75) Inventors: Yoshihiro Takami, Tokyo (JP); Ryo Yamaguchi, Tokyo (JP); Yasushi Matsuda, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Yoshisiro Takami, Chofu-shi, Tokyo (JP)

(21) Appl. No.: 10/584,630

(22) PCT Filed: Dec. 24, 2004
(86) PCT No.: PCT/JP04/19760

§ 371 Date: Dec. 28, 2006

(30) Foreign Application Priority Data
Dec. 25, 2003 (JP) 2003-430492
Jan. 30, 2004 (JP) 2004-024351

(51) Int. Cl. A01N 1/00

(52) U.S. Cl. 435/1.1

(57) ABSTRACT

An object of the present invention is to provide a method for producing an ADM suitable as a scaffold for a cultured skin, that is, a separation and decellularization method that enables various types of extracellular matrixes such as a basement membrane to be preserved, allows the epidermal layer to be peeled off easily, and does not cause any damage to the dermal matrix. The present invention relates to a skin separation and decellularization method comprising a step of freeze thawing harvested skin and then separating the skin into epidermis and dermis by a treatment with hypertonic saline, and a step of washing the separated dermis.

### TECHNICAL FIELD

The present invention relates to a method for separating and decellularizing harvested skin, an acellular dermal matrix obtained by said separation and decellularization method, and a method for producing an acellular dermal matrix utilizing said separation and decellularization method, and also relates to composite cultured epithelium and skin employing said acellular dermal matrix as a scaffold.

### BACKGROUND ART

Since the development of a method for culturing sheet-form epidermal keratinocytes by Rheinwald and Green in 1975 (ref. e.g. Rheinwald J G & Green H: Serial cultivation of human epidermal keratinocytes: the Cell formation of keratinizing colonies from single cells. Cell. 1975; 6:331-344), research into cultured skin as means for reconstructing skin damaged by burns or wounds has been carried out. The cultured epidermal keratinocytes sheet of Green et al. was the first cultured skin to be clinically applied, by O'Connor et al. in 1981 (ref. e.g. O'Connor N E, Mulliken J B, Banks-Schlegel S, et al.: Grafting of burns with cultured epithelium prepared from autologous epidermal cells. Lancet. 1981; 1:75-78). However, since it does not contain a dermal component, for a full thickness skin defect the survival rate is poor due to effusion or bacterial contamination, and even if it survives, blisters or ulcers easily occur, which is a serious problem (ref. e.g. Nanchahal J & Ward C M: New grafts for old? A review of alternatives to autologous skin. Brit J Plast Surg. 1992; 45:354-363). Because of this, the importance of the dermal component in cultured skin has been recognized, and various types of cultured skin employing dermal material as a cellular scaffold (support) have been developed to date.

At present, as a main scaffold for cultured skin into which keratinocytes have been incorporated, a bioabsorbable synthetic polymer such as Vicryl (registered trademark) (ref. e.g. Hansbrough J F., Morgan J L., Greenleaf G E., et al.: Composite grafts of human keratinocytes grown on a polyglactin mesh cultured fibroblasts dermal substitute function as a bilayer skin replacement in full-thickness wounds on athymic mice. Burn Care Rehabil. 1993; 14:485-494), an artificial dermis formed from biologically-derived materials such as a collagen gel (ref. e.g. Bell E., Ehrlich H P., Buttle D J., et al,: Living tissue formed in vitro and accepted as skin-equivalent tissue of full-thickness. Science. 1981; 211:1052-1054) or a collagen sponge such as C-GAG (ref. e.g. Boyce S T., Christianson D., Hansbrough J F.: Structure of a collagen-GAG skin substitute optimized for cultured human epidermal keratinocytes. J Biomed Mater Res. 1988; 22:939-957), or a biological skin tissue-derived acellular dermal matrix (ADM) (ref. e.g. Livesey S A, Herndon D N, Hollyoak M A, et al.: Transplanted acellular allograft dermal matrix. Potential as a template for the reconstruction of viable dermis. Transplantation. 1995; 60:1-9, Wainwright D J. Use of an acellular dermal matrix (AlloDerm) in the management of full-Thickness burns. Burns. 1995; 21:243-248), etc. is used. The Vicryl (registered trademark) referred to here is a bioabsorbable synthetic polymer (polyglactin-910) formed by copolymerization of glycolic acid and lactic acid at a ratio of 9:1, and is used clinically as an absorbable surgical suture or net. Dermagraft (registered trademark) is an artificial dermis formed by embedding fibroblasts into the polyglactin as a scaffold, and Hansbrough et al. have reported that they have produced composite cultured skin by seeding epidermal keratinocytes on Dermagraft (registered trademark). Furthermore, the C-GAG (Collagen-Glycosaminoglycan) referred to here is one that was developed by Yannas et al. in 1980 as a collagen sponge by copolymerization of collagen and chondroitin hexasulfate, which is one type of glycosaminoglycan. In 1988 Boyce et al. reported that they had produced cultured skin by seeding C-GAG with epidermal keratinocytes.

Among the above-mentioned scaffolds, ADM is able to be a skin model that is the most similar to a living body when it is used as a scaffold for the cultured skin since it has a physiological dermal structure. However, ADM was originally developed as a dermal substitute for reconstructing a damaged dermal portion in skin grafting or in simultaneous grafting with cultured epidermis. Composite skin based on ADM as a scaffold is currently being investigated in various ways, but the investigations are at the stage of basic research; there have been hardly any reports of clinical application to humans, and it is not at the point where it can be put to practical use. As one of the lines of basic research, an allogeneic skin decellularization method can be cited. There are several allogeneic skin decellularization methods, and it is possible to preserve various extracellular matrixes contained within the dermis, including epidermal basement membrane. However, the degree to which the basement membrane components are preserved depends on the decellularization method, and there are many points that are unclear with regard to the extent to which the preserved components affect cultured cells.

Among various allogeneic skin separation and decellularization methods, it is known that a method in which an epidermal layer is peeled off from a dermal layer using a treatment with 1 M sodium chloride gives the best degree of preservation of the basement membrane. However, because of individual differences of allogeneic skin, it is difficult in some cases to peel off the epidermal layer using only the treatment with 1 M sodium chloride, and the treatment time is as long as 18 to 24 hours. Furthermore, in order to completely decellularize the interior of the dermal matrix, it is necessary to remove residual intradermal cells. It is well known that SDS, etc., which is a surfactant, is used in a method for removing intradermal cells. AlloDerm (registered trademark, LifeCell Corporation, US), which is an allogeneic acellular dermal matrix manufactured in the USA, has been treated with 1 M sodium chloride and SDS (ref. e.g. Livesey S A, Herndon D N, Hollyoak M A, et al.: Transplanted acellular allograft dermal matrix. Potential as a template for the reconstruction of viable dermis. Transplantation. 1995; 60:1-9, Wainwright D J. Use of an acellular dermal matrix (AlloDerm) in the management of full-Thickness burns. Burns. 1995; 21:243-248). However, there is a possibility that a treatment method employing SDS, which is a surfactant, might damage the basement membrane or the dermis.

### DISCLOSURE OF INVENTION

It is therefore an object of the present invention to provide a method for preparing an ADM suitable as a scaffold for cultured skin, that is, a separation and decellularization method that enables various extracellular matrixes, including basement membrane, to be preserved, enables an epidermal layer to be easily peeled off, and does not cause any damage to a dermal matrix; an acellular dermal matrix obtained by the separation and decellularization method; and a method for producing an acellular dermal matrix employing the separation and decellularization method, and it is another object thereof to provide a composite cultured epithelium such as a composite cultured skin employing the acellular dermal matrix as a scaffold.

The present inventors have examined a method for preparing an ADM suitable as a scaffold for cultured skin, and have found that, by freeze thawing allogeneic skin prior to a treatment with 1 M sodium chloride, it is possible to easily peel off an epidermal layer, and that a running water washing method employing PBS is suitable as a method for removing intradermal cells, and the present invention has thus been accomplished. Furthermore, it has also been found that, when the above-mentioned method is applied to mammalian skin other than allogeneic human skin, a good ADM is obtained.

The present invention is therefore a skin separation and decellularization method that includes a step of freeze thawing harvested skin and then separating the skin into epidermis and dermis by a treatment with hypertonic saline, and a step of washing the separated dermis.

Furthermore, the present invention is an acellular dermal matrix that has been separated and decellularized by a step of freeze thawing harvested skin and then separating the skin into epidermis and dermis by a treatment with hypertonic saline, and a step of washing the separated dermis.

Moreover, the present invention is a method for producing an acellular dermal matrix, the method including a step of freeze thawing harvested skin and then separating the skin into epidermis and dermis by a treatment with hypertonic saline, and a step of washing the separated dermis.

Furthermore, the present invention is a composite cultured skin employing the above-mentioned acellular dermal matrix as a substrate.

Moreover, the present invention is a composite cultured epithelium employing the above-mentioned acellular dermal matrix as a substrate.

The disclosures of the present application relate to subject matter described in Japanese Patent Application No. 2003430492 filed on Dec. 25th, 2003 and Japanese Patent Application No. 2004-24351 filed on Jan. 30th, 2004, and the contents of the disclosures therein are incorporated herein by reference.

### BRIEF DESCRIPTION OF DRAWINGS

FIG. 1 is a photographic diagram showing the histology of allogeneic human skin (top) and acellular dermal matrixes obtained by Methods 1 to 5 (H&E staining, magnification 100 times) (bottom). Samples shown in photographs (1) to (5) were obtained by Methods 1 to 5 respectively. 11 denotes epidermal keratinocytes, 12 denotes epidermis, 13 denotes dermal fibroblast, and 14 denotes dermis.

FIG. 2 is a photographic diagram showing images in which type IV collagen is stained in the acellular dermal matrixes obtained by Methods 1 to 5 (immunohistrochemical staining, magnification 200 times). Samples shown in photographs 1 to 5 were obtained by Methods 1 to 5 respectively.

FIG. 3 is a photographic diagram showing images in which laminin is stained in the acellular dermal matrixes obtained by methods 1 to 5 (immunohistrochemical staining, magnification 200 times). Samples shown in photographs 1 to 5 were obtained by Methods 1 to 5 respectively.

FIG. 4 is a conceptual diagram showing a method for preparing composite cultured skin employing an acellular dermal matrix as a scaffold.

FIG. 5 is a photographic diagram showing the histology of composite cultured skin employing the acellular dermal matrixes obtained by Methods 1 to 5 as a scaffold (H&E staining, magnification 200 times). Samples shown in photographs 1 to 5 were obtained by Methods 1 to 5 respectively. 15 denotes an epidermal layer.

FIG. 6 is a photographic diagram showing images in which type IV collagen is stained in composite cultured skin employing the acellular dermal matrixes obtained by Methods 1 to 5 (immunohistrochemical staining, magnification 200 times). Samples shown in photographs 1 to 5 were obtained by Methods 1 to 5 respectively.

FIG. 7 is a photographic diagram showing images of a composite cultured skin graft of the present invention (immediately after grafting (top) and on the 22nd day (middle)), and a photographic diagram showing a skin section after grafting the composite cultured skin of the present invention (13th day) (H&E staining, magnification 100 times) (bottom). 16 denotes cultured skin and 17 denotes a graft bed.

FIG. 8 is a photographic diagram showing cultured mucous membrane tissue employing the acellular dermal matrix of the present invention as a scaffold (H&E staining, magnification 200 times). 18 denotes oral mucousal keratinocytes, and 19 denotes dermis.

FIG. 9 is a photographic diagram showing cultured small intestinal tissue employing the acellular dermal matrix of the present invention as a the scaffold (H&E staining, magnification 200 times). 20 denotes small intestinal epithelial cells, and 21 denotes dermis.

FIG. 10 is a photographic diagram showing the histology of porcine skin (top) and an acellular dermal matrix obtained in Example 6 (H&E staining, magnification 100 times) (bottom).

FIG. 11 is a photographic diagram showing images in which type IV collagen (top) and laminin (bottom) are stained in the acellular dermal matrix obtained in Example 6 (immunohistrochemical staining, magnification 100 times).

### BEST MODE FOR CARRYING OUT THE INVENTION

Mammalian skin, such as allogeneic human skin, is the best wound covering material since it has cellular components and a physiological skin structure, but because it contains allogeneic or xenogeneic cells, an epidermal cell layer comes off within a few weeks after grafting due to immunological rejection. In order to suppress the immunological rejection and enable permanent survival, all cells are removed to thus give an acellular dermal matrix (ADM).

Various methods for separating and decellularizing skin tissue have been reported. In 1972, Oliver et al. decellularized porcine skin by a treatment with a protease employing trypsin (Oliver R F., Grant R A, and Kent C M.: The fate of cutaneously and subcutaneously implanted trypsin purified dermal collagen in the pig. Br J exp Path. 1972; 53:540-549). In 1987, Grinnel et al. carried out separation and decellularization of skin by a physical method in which skin was freeze-thawed and the epidermis was then peeled off from the dermis using tweezers (Grinnel F., Toda K., and Lamke-Seymour C.: Reconstruction of human epidermis in vitro is accompanied by transient activation of basai keratinocyte spreading. Exp Cell Res. 1987; 172:439-449). In 1990, Sasamoto et al. prepared an ADM of rat skin by a Dispase treatment (Sasamoto Y., Alexamder J W., and Babcock G F.: Prolonged survival of reconstituted skin grafts without immunosuppression. J Burn Care Rehabil. 1990; 11:190-200).

With regard to a method related to the separation and decellularization method of the present invention, in 1996 Takami et al. reported a decellularization method employing a combination of Dispase and Triton X-100, which is a detergent (Takami Y., Matsuda T., Yoshitake M., et al.: Dispase/detergent treated dermal matrix as a dermal substitute. Burns. 1996; 22:182-190). Furthermore, AlloDerm (registered trademark, LifeCell Corporation, US) is formed by peeling off the epidermal layer with 1 M sodium chloride and then dissolving and removing remaining intradermal cells using SDS, which is a detergent (Livesey S A, Hemdon D N, Hollyoak M A, et al.: Transplanted acellular allograft dermal matrix. Potential as a template for the reconstruction of viable dermis. Transplantation. 1995; 60:1-9; Wainwright D J. Use of an acellular dermal matrix (AlloDerm) in the management of full-thickness burns. Burns. 1995; 21:243-248). In the above-mentioned physical method involving freeze thawing, it is difficult to completely remove intradermal cells, and the dermal collagen or the basement membrane structure is broken by excessive freeze thawing or physical epidermal peeling by tweezers. Furthermore, since the chemical method, which employs a protease such as trypsin or Dispase, exhibits the action of denaturing or decomposing not only the basement membrane but also dermal tissue formed from collagen fiber, the decellularization treatment time is important. In contrast, the treatment with 1 M sodium chloride enables the basement membrane or the dermal tissue to be preserved intact, but it is necessary to further remove remaining intradermal cells.

For removing intradermal cells, in addition to a method employing a detergent such as SDS or Triton X-100, there has been reported a method in which removal is carried out by washing with PBS. Marshall et al. have produced a preserved basement membrane type ADM by washing a dermal portion with PBS for a period of time as long as 4 to 8 weeks after a treatment with 1 M sodium chloride (Marshall L., Ghosh M M., Boyce S G., et al.: Effect of glycerol on intracellular virus survival; Implications for the clinical use of glycerol-preserved cadaver skin. Burns. 1995; 21:356-361). By the treatment with a detergent, it is possible to produce an ADM in which the basement membrane is retained, but there is a possibility that due to the use of a chemical component the dermal matrix might be damaged. Walter et al. have suggested that in an ADM produced using sodium chloride and then SDS, various extracellular matrixes such as the basement membrane decreased compared with those in skin tissue (Walter R J., Matsuda T., Reyes H M., et al.: Characterization of acellular dermal matrices (ADMs) prepared by two different methods. Burns. 1998; 24:104-113). However, it has not been clarified whether the decrease is due to sodium chloride or SDS. In the examples described below, it has been found that, compared with an ADM treated with PBS after treatment with sodium chloride, an ADM treated with SDS has a reduction in basement membrane or intradermal vascular basement components. That is, it has become clear that the reduction in the extracellular matrix is due to SDS.

With regard to the skin of a living body, rupture of the basement membrane causes various diseases such as bullosa, and there are many reports relating to the importance of the basement membrane (Yancey KB.: Adhesion molecules. II: Interactions of keratinocytes with epidermal basement membrane. J Invest Dermatol. 1995; 104:1008-1014), and the importance thereof is no different for the composite cultured skin. The basement membrane is formed from a three-layer structure of a lamina densa, a lamina lucida, and a fibrorecticular lamina, and contains as main components type IV collagen, laminin, fibronectin, heparan sulfate, and entactin, and the basement membrane enhances attachment between epidermal keratinocytes and dermis, together with adhesive fibers such as hemidesmosomes or anchoring fibrils. The basement membrane not only strengthens the attachment to epidermal keratinocytes, but also has a barrier effect toward permeation of a substance or a function of adjusting the arrangement or specialization of epidermal keratinocytes. An ADM that is intended to be a scaffold for a cultured skin desirably retains these basement membrane structures intact.

Ojeh et al. have reported that, when preserved basement membrane type ADM and C-GAG were seeded with epidermal keratinocytes, and formation of an epidermal layer was compared, the ADM exhibited a better degree of formation of the epidermal layer (Ojeh. N. O., Frame. J. D., F.R.C.S., et al.: In vitro characterization of an Artificial dermal scaffold. Tissue Engineering. 2001:7:457-472). Ralston et al. have reported that preserved basement membrane type ADM has higher attachment to epidermal keratinocytes and a higher degree of formation of an epidermal layer compared with non-preserved type ADM (Ralston D R, Layton C, Dailey A J, et al.: The requirement for basement membrane antigens in the production of human epidermal/dermal composites in vitro. British Joumal of Dermatology 1999; 140:605-615). In the examples described later, although there was no noticeable difference in the formation of an epidermal layer due to differences in the degree to which the basement membrane was preserved, there was a clear difference in the attachment of the epidermal layer. Furthermore, the new formation of a basement membrane by epidermal keratinocytes was not observed either. From these results, it is clear that as a method for producing an ADM as a scaffold for cultured skin, a method employing 1 M sodium chloride, which can preserve the basement membrane components, is suitable, and for removal of intradermal cells, a method involving washing with PBS has high degree of stability for the preservation of the basement membrane.

Moreover, a composite cultured skin in which fibroblasts and epidermal keratinocytes are incorporated into an ADM was reported by Ghosh et al. in 1997 (Ghosh M M, Boyce S, Layton C, et al: A Comparison of Methodologies for the Preparation of human Epidermal-Dermal Composites. Annals of Plastic Surgery. 1997; 39:390-404), but from that time up to the present, similar research has been focused on an allogeneic skin decellularization method, an ADM sterilization method, a cultured cell incorporation method, etc. (Manimalha Balasubramani, T Ravi Kumar, Mary Babu: Skin substitutes: a review. Burns. 2001; 27:534-544), and with regard to reports on the grafting onto a living body of cultured skin in which epidermal cells (keratinocytes) are seeded on an ADM, the only case confirmed so far is that by Chakrabarty et al. in which a nude mouse was used (Chakrabarty K H, Dawson R A, Harris P, et al.: Development of autologous human dermal-epidermal composites based on sterilized human allodermis for clinical use. British Joumal of Dermatology 1999; 141:811-823). Furthermore, with regard to cultured epithelium, there is only a report by Izumi et al. relating to the grafting onto a mouse of a composite cultured oral mucosa based on AlloDerm (Izumi K, Feinberg S E, Terashi H, et al.: Evaluation of transplanted tissue-engineered oral mucosa equivalents in severe combined immunodeficient mice. Tissue Eng. 2003; 9:163-174). That is, the clinical complete grafting of composite cultured skin has been achieved for the first time by the inventors of the present invention. Furthermore, since it is recognized that the present ADM has compatibility with oral mucousal keratinocytes or small intestinal epithelial cells, the ADM is expected to be applied not only to skin but also to the medical treatment of tissue regeneration employing various epithelial cells.

The separation and decellularization method of the present invention is explained below. The separation and decellularization method of the present invention is a method in which skin harvested from an allogeneic or xenogeneic mammal, including man, is used, the epidermis and dermis of this skin are separated in a state in which an extracellular matrix, such as the basement membrane, is preserved in the dermis, and the separated dermis is further decellularized. The skin harvested from an allogeneic or xenogeneic mammal used in the present invention referred to here is skin harvested from an allogeneic or xenogeneic animal with respect to man or another animal that requires a treatment such as skin grafting as a medical treatment for a bum, etc.; it is preferably skin originating from an allogeneic animal, and there is no distinction as to whether or not the skin is autologous. When allogeneic human skin is employed, it is also possible to utilize surplus skin that becomes unwanted after surgery or the harvesting of allogeneic skin, skin obtained from a dead body, etc., and it is also possible to employ skin cryopreserved in a skin bank, etc. This skin is suitably used as split-thickness skin having an average thickness of on the order of 0.38 mm (average thickness of about 0.015 inch). Furthermore, in the present invention, it is possible to use xenogeneic animal-derived skin; examples of such mammals include pig, cow, monkey, rabbit, rat, mouse, goat, sheep, and horse, and it is preferable to use porcine skin in the present invention. It is desirable to use such skin as split-thickness skin having an average thickness of on the order of 0.38 mm (average thickness of about 0.015 inch).

In the present invention, separation of the harvested skin into epidermis and dermis is carried out by a step of freeze thawing harvested skin and a step of treating with hypertonic saline. This process enables the epidermis and the dermis to be easily separated in a state in which the extracellular matrix, including the basement membrane, remains in the dermis.

In the freeze-thawing step, freezing is carried out by holding the harvested skin at a temperature of −20° C. or less, and more preferably −20° C. to −80° C., for 24 to 48 hours, and subsequently at a temperature of −190° C. or less using liquid nitrogen, and more preferably −190° C. to −200° C. The time for which it is held is not particularly limited, and is preferably at least 48 hours, and it is possible for it to be held semipermanently. Thawing is carried out preferably by holding the frozen skin at a temperature of 20° C. to 37° C. for 5 minutes or longer, and preferably 5 to 10 minutes.

Furthermore, the hypertonic saline referred to in the present invention is preferably a salt solution having a concentration of 0.8 to 2.0 M, more preferably 0.9 to 1.5 M, and most preferably 0.9 tol.1 M. Examples of the hypertonic saline include an aqueous solution of sodium chloride and an aqueous solution of potassium chloride, and the aqueous solution of sodium chloride is preferable. The hypertonic saline may freely contain another additive component such as a vitamin, a preservative, or an antibiotic.

A treatment with the hypertonic saline involves immersing skin in the hypertonic saline, and preferably involves immersing in the mixed solution and agitating in the mixed solution. The temperature of immersion and agitation may be any temperature as long as the skin that is to be treated undergoes substantially no denaturation; the temperature is generally 20° C. to 37° C., but it is not limited thereto. A treatment time of on the order of 8 to 12 hours is sufficient, but it may be set at a shorter time or a slightly longer time while taking into consideration the separation conditions.

With regard to the separation step in the present invention, by subjecting the skin to the freeze-thawing treatment prior to treating it with hypertonic saline, it is possible to reduce the time taken for peeling of the epidermal layer, and in accordance with this step, the skin harvested from an allogeneic or xenogeneic mammal, including man, is completely separated into the dermis and the epidermis in a state in which the basement membrane is preserved in the dermis, without destroying the dermal collagen or the basement membrane structure.

Subsequently, the dermis thus obtained is decellularized by a washing step. The washing may normally employ an isotonic solution such as an isotonic buffer solution or an isotonic saline or sterile water, but in the present invention it is preferable to use an isotonic buffer solution. This step is a step of physically removing intradermal cells using a culture insert petri dish that enables three-dimensional culturing, represented by a device such as a TransWell (Cat No.3403: registered trademark, manufactured by CORNING), by placing the separated dermis on a permeable membrane and continuously feeding through an isotonic buffer solution from the top of the dermis, that is, from the basement membrane side. A device such as a TransWell is preferably used since PBS can be poured as a flow over the separated dermis. As the isotonic buffer solution, any kind may be used; in the present invention examples thereof include PBS (Phosphate Buffered Saline) and HBSS (Hanks' Balanced Salt Solution), and PBS is preferably used. As the isotonic saline, any kind may be used, and in the present invention examples thereof include an aqueous solution of sodium chloride and an aqueous solution of potassium chloride. The isotonic solution or the sterile water, etc. used in this step may freely contain another additive component such as vitamin, a preservative, or an antibiotic.

A method for feeding the isotonic buffer solution during washing preferably involves directly feeding the isotonic buffer solution onto the surface of the dermis by a pipette operation until the dermis is completely immersed in the solution, and subsequently feeding the isotonic buffer solution onto the surface of the dermis in a state in which the dermis is completely immersed in the solution. The flow rate of the isotonic buffer solution is preferably 10 to 30 mL/5 to 10 sec when a 100 mm petri dish is used as the petri dish, more preferably 15 to 30 mL/5 to 10 sec, and particularly preferably 15 to 25mL/5 to 10 sec. The temperature during washing may be any temperature as long as the dermis to be washed undergoes substantially no denaturation, and it is generally 20° C. to 37° C. but is not limited thereto. A washing time of on the order of 1 week is sufficient, but it may be set at a shorter time or a slightly longer time while taking into consideration of the decellularization conditions.

The decellularization step of the present invention employs a method in which an isotonic buffer solution, etc. is poured onto the dermis; this running water method enables the time required for removal of cells to be reduced, and the present step enables a dermal matrix that has been reliably decellularized to be obtained while retaining the normal dermal matrix structure.

In a preferred specific example of the separation and decellularization method, after skin harvested from an allogeneic mammal is frozen (at a temperature of −80° C. for 24 hours, and subsequently using liquid nitrogen at a temperature of −196° C. for 48 hours) and thawed (at a temperature of 37° C. for 5 minutes), the skin is immersed in 1 M sodium chloride and agitated at 37° C. for 12 hours, thus separating the dermis and the epidermis in a state in which the basement membrane is preserved in the dermis. Subsequently, the dermal portion thus separated is continuously washed at 37° C. for 1 week by feeding PBS from the top using a TransWell. As a result of this treatment, substantially all of the cellular components (cutaneous appendage cells, vascular cells, fibroblasts, nervous system cells, others) within the dermis are removed, and the dermis becomes a dermal matrix in which the basement membrane is preserved and which mainly contains collagen.

The decellularization method of the present invention may include, in addition to the above-mentioned steps, a step of immersing the harvested skin in an approximately 0.1% to 10% aqueous solution of sodium azide for a few minutes to a few days to thus carry out sterilization. Furthermore, the decellularization method of the present invention may include in any stage a step of sterilizing the harvested skin, the separated dermis, or the decellularized dermis by the application of y-rays or an electron beam, etc. The decellularization method of the present invention may further include any step.

The dermis (matrix) thus decellularized may be utilized as it is as the acellular dermal matrix of the present invention, or may be used after being kept in cold strage.

Preferably, with respect to the acellular dermal matrix obtained as above, it is confirmed, by subjecting a part of the dermal matrix to bacterial and fungal culturing, that there is no bacterial or fungal growth. More preferably, it is confirmed by a pathological test involving hematoxylin eosin staining that there is substantially no abnormality in the dermal collagen structure and the matrix is substantially completely acellular. Yet more preferably it is confirmed, by confirming the presence of type IV collagen and laminin by immunochemical staining, that the basement membrane is substantially preserved.

Compared with the conventional methods, the above-mentioned decellularization method/acellular dermal matrix production method are excellent methods that enable an extracellular matrix such as a basement membrane to be preserved and decellularization to be reliably carried out while retaining the normal dermal matrix structure.

In the acellular dermal matrix produced as above, an extracellular matrix such as a basement membrane is preserved, it is substantially acellular, there is very little damage to the normal intradermal collagen structure, and a three-dimensional intradermal collagen structure is retained.

Furthermore, in the present invention, the acellular dermal matrix can be applied to mammals, including man, and it can be used as a scaffold for a composite cultured skin that can be grafted in place of a conventional collagen matrix, in particular, as an allogeneic or xenogeneic human acellular dermal matrix.

Moreover, cultured tissue other than skin may be obtained using the acellular dermal matrix of the present invention as a scaffold, the cultured tissue having allogeneic or xenogeneic cultured oral mucousal keratinocytes, cultured epithelial cells, etc. incorporated thereinto.

The acellular dermal matrix production method of the present invention is an excellent method that enables the epidermis to be easily peeled off in a state in which the basement membrane remains in the dermis and, furthermore, enables decellularization to be reliably carried out while retaining the normal dermal matrix structure. The human allogeneic or xenogeneic acellular dermal matrix produced by the method of the present invention can be used as an optimum matrix (scaffold) for cultured epidermal tissue for the purpose of a tissue regeneration medical treatment or research using cultured tissue, that is, as an optimum matrix for attachment of cultured cells or overlayering of cultured cells. Furthermore, the acellular dermal matrix of the present invention can be used as a scaffold for cultured tissue of not only the skin but also the mucous membrane or the intestinal epithelium, and has wide application to epidermal tissue in general. Furthermore, compared with an animal collagen matrix such as a collagen gel or a collagen sponge and a scaffold formed from an artificial product such as a conventional ADM or Vicryl, the composite cultured skin employing the acellular matrix of the present invention has excellent attachment after overlayering cultured cells and excellent stability as a cultured tissue, and can be applied clinically.

### EXAMPLES

The present invention is explained below in further detail by reference to Examples, but the present invention should not be construed as being limited to these Examples.

### Example 1

In order to examine the characteristics and advantages of the acellular dermal matrix production method of the present invention, it was compared with conventionally reported separation and decellularization methods.
Method 1 (1 M NaCl+PBS) (1)

Surplus skin (split-thickness skin: average thickness of about 0.38 mm: 0.015 inch thick) that was unwanted during surgery or after harvesting allogeneic skin was frozen using liquid nitrogen (at a temperature of −80° C. for 24 hours, and subsequently at a temperature of −196° C. for 48 hours), then thawed (at a temperature of 37° C. for 5 minutes), then immersed in 1 M NaCl, and incubated at 37° C. for 12 hours. This treatment allowed the epidermis and the dermis to be easily separated in a state in which the basement membrane remained in the dermis.

The dermal portion thus obtained was continuously washed using a TransWell with PBS (37° C.) for 1 week. This treatment allowed all the cellular components (cutaneous appendage cells, vascular cells, fibroblasts, nervous system cells, others) within the dermis to be removed, thus converting the dermis into a dermal matrix in which the basement membrane was preserved and which contained mainly collagen.
Method 2 (1 M NaCl+Triton X-100) (2)

This was a method in which surplus skin was frozen using liquid nitrogen and thawed, and 1 M NaCl and the detergent Triton X-100 (product name) were then used in sequence. That is, a method in which, when split-thickness skin was separated into epidermis and dermis, a treatment with 1 M NaCl was carried out subsequent to freeze-thawing, and in a decellularization treatment of the separated dermis a treatment with Triton X-100 was carried out.
Method 3 (1 M NaCl+SDS) (3)

This was a method in which surplus skin was frozen using liquid nitrogen and thawed, and 1 M NaCl and the detergent SDS (Sodium Dodecyl Sulfate) were then used in sequence. That is, a method in which, when split-thickness skin was separated into epidermis and dermis, a treatment with 1 M NaCl was carried out subsequent to freeze-thawing, and in a decellularization treatment of the separated dermis a treatment with SDS was carried out.
Method 4 (Dispase) (4)

This was a method in which surplus skin was frozen using liquid nitrogen and thawed, and then when the split-thickness skin was separated into epidermis and dermis, only the protease Dispase was used.
Method 5 (trypsin+Triton X-100) (5)

This was a method in which surplus skin was frozen using liquid nitrogen and thawed, and the protease trypsin and the detergent Triton X-100 (product name) were then used in sequence. That is, a method in which, when split-thickness skin was separated into epidermis and dermis, a treatment with trypsin was carried out subsequent to freeze-thawing, and in a decellularization treatment of the separated dermis a treatment with Triton X-100 was carried out.

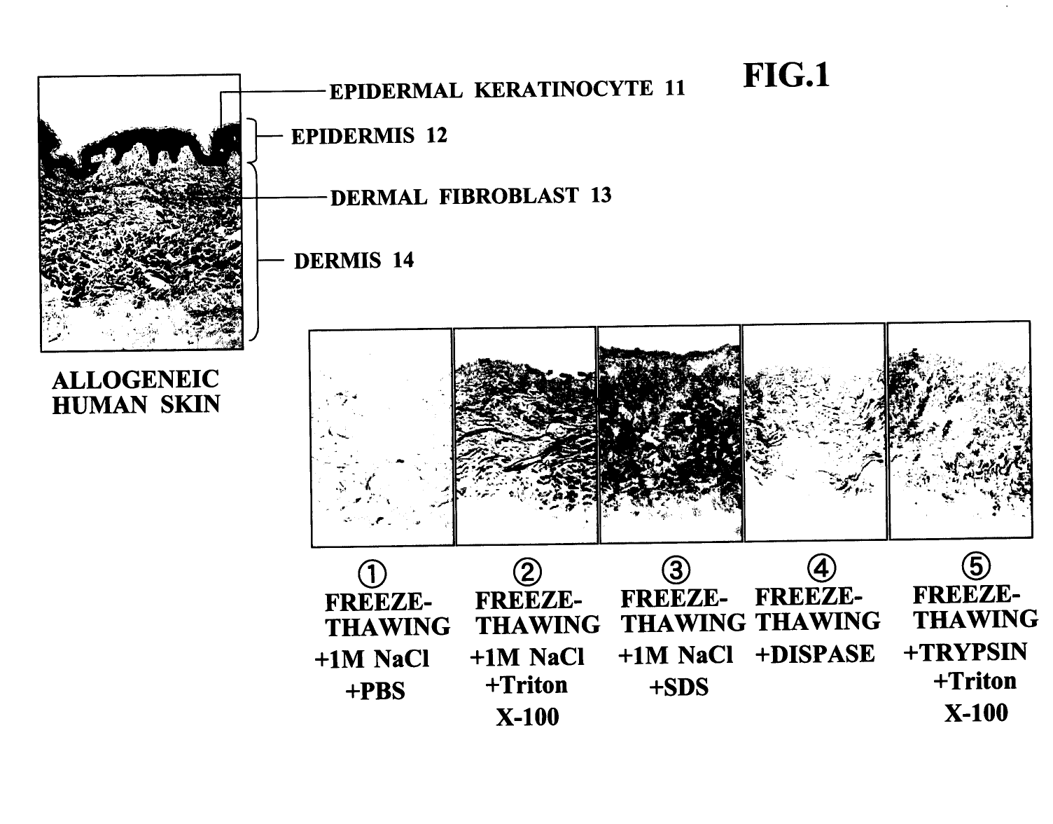

The properties of the ADMs obtained by the above-mentioned five methods were examined. FIG. 1 shows photographs of allogeneic human skin after H&E staining and cross sections of the ADMs obtained by Methods 1 to 5. In the photograph of the cross section of the allogeneic human skin, portions stained bluish-purple correspond to epidermal keratinocytes or dermal fibroblast nuclei. In the allogeneic human skin, the epidermal layer and the dermal fibroblasts could be confirmed. On the other hand, in all the ADMs obtained by Methods 1 to 5, it could be confirmed that the epidermal layer had been peeled off and the dermal fibroblasts had been removed. That is, the ADMs obtained were completely decellularized (FIG. 1, Table 1).

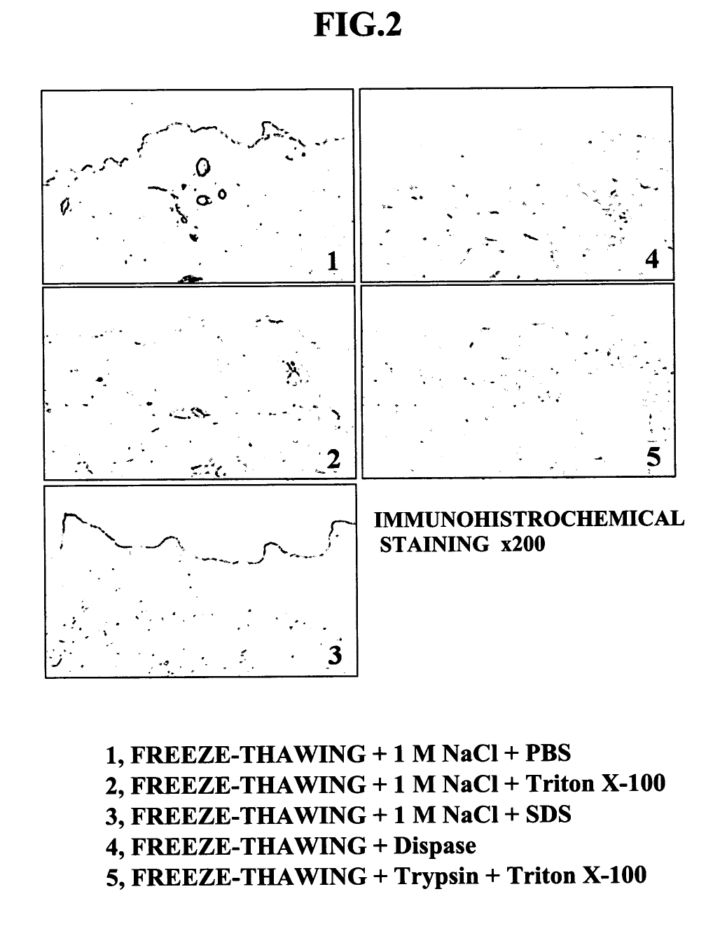

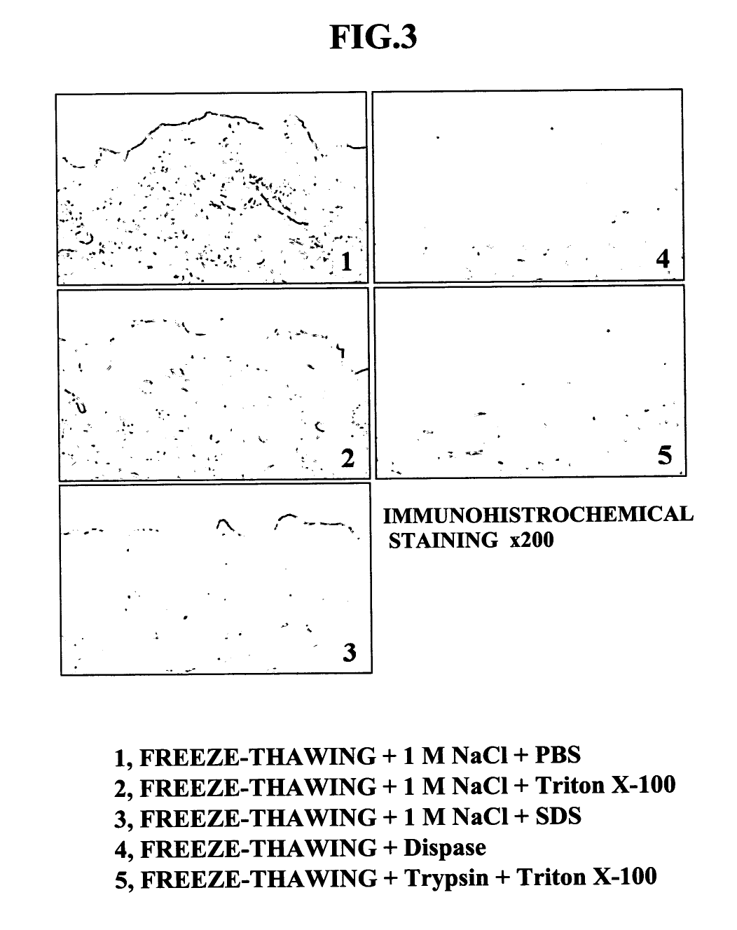

Furthermore, by immunochemically staining type IV collagen and laminin, which are basement membrane components, the degree to which the basement membrane was preserved was confirmed. FIG. 2 and FIG. 3 are photographs of cross sections of ADMs obtained by Methods 1 to 5 subsequent to the immunochemical staining, and the brown-stained portions correspond to type IV collagen and laminin. In FIG. 2 and FIG. 3, in ADMs obtained by Methods 1 and 2 many strongly brown-stained portions were observed, in the ADM obtained by Method 3 some stained portions were observed, and in ADMs obtained by Methods 4 and 5 no stained portions were observed. That is, it was confirmed that in the ADMs subjected to an epidermal peeling off treatment using 1 M NaCl in Methods 1, 2, and 3, the basement membrane was preserved (FIG. 2 and FIG. 3, Table 1). Among these, the highest degree of preservation was observed for the ADM obtained by Method 1. In contrast thereto, in the ADMs subjected to a treatment with a protease in Methods 4 and 5, most of the basement membrane was decomposed.

TABLE 1
Properties of various types of ADMs

| | | Temperature/ | Cell | Type IV | |
|---|---|---|---|---|---|
| Method | | Time | Removal | Collagen | Laminin |
| (1) | Freeze-thawing | *1 | good | +++ | ++ |
| | + 1 M NaCl | 37° C./12 hrs | | | |
| | + PBS | 37° C./1 weeks | | | |
| (2) | Freeze-thawing | *1 | good | +++ | ++ |
| | + 1 M NaCl | 37° C./12 hrs | | | |
| | + Triton X-100 | 37° C./4 hr | | | |
| (3) | Freeze-thawing | *1 | good | ++ | + |
| | + 1 M NaCl | 37° C./12 hrs | | | |
| | + SDS | 37° C./1 hr | | | |
| (4) | Freeze-thawing | *1 | good | − | − |
| | + Dispase | 37° C./12 hrs | | | |
| (5) | Freeze-thawing | *1 | good | − | − |
| | + Trypsin | 37° C./4 hrs | | | |
| | + Triron X-100 | 37° C./4 hrs | | | |

*1 −80° C./24 h + −196° C./48 h + 37° C./5 min
In Table 1, evaluation was carried out by visual observation, and the judgment criteria for each evaluation item were as follows.
<Cell removal>
Good: Cells were completely removed from an ADM.
<Type IV collagen>
+++: Type IV collagen was stained most strongly in the basement membrane portion and within the dermis.
++: Type IV collagen was stained only in the basement membrane portion.
−: Type IV collagen was not stained in the basement membrane portion or within the dermis.
<Laminin>
++: laminin was stained strongly in the basement membrane portion and within the dermis.
+: laminin was stained in part of the basement membrane portion.
−: laminin was not stained in the basement membrane portion or within the dermis.

### Example 2

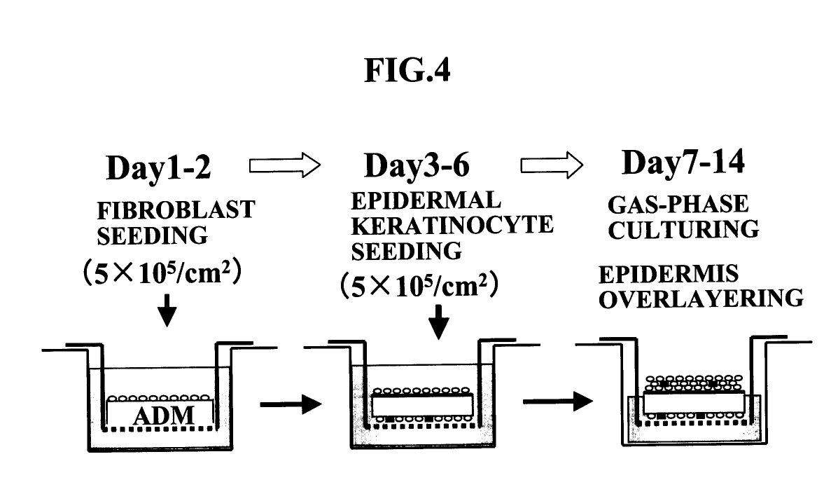

In accordance with FIG. 4, each of the ADMs obtained in Example 1 was seeded with fibroblasts, and then with epidermal keratinocytes, and the epidermal keratinocytes were overlayered by air-liquid interface culturing for 1 week, thus giving a composite cultured skin.

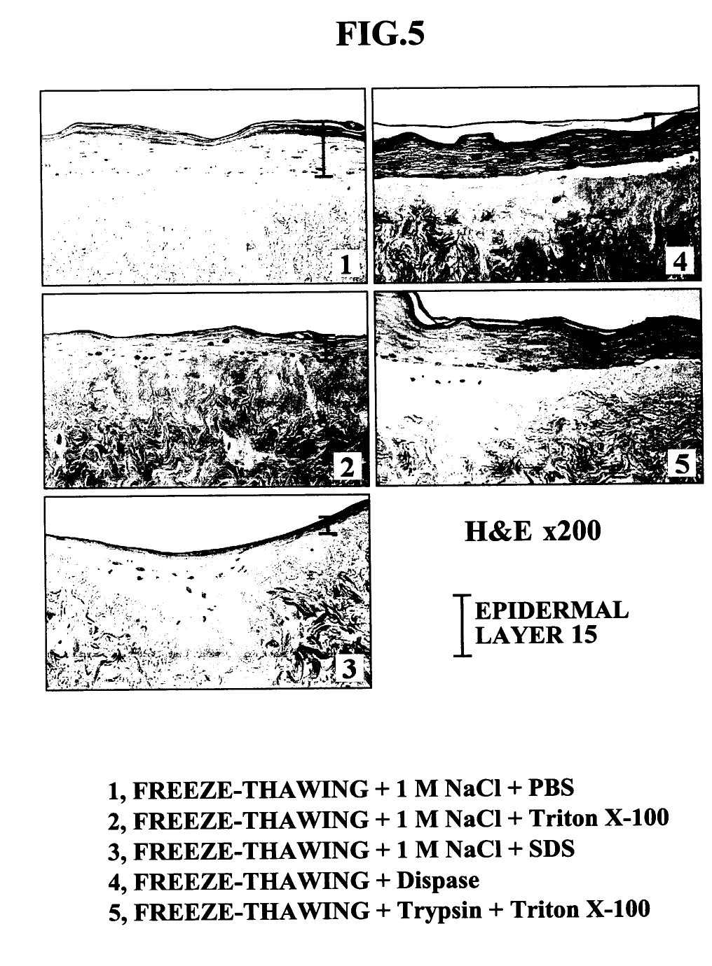

The properties of each composite cultured skin thus obtained were examined by carrying out H&E staining. FIG. 5 shows photographs of cross sections of the composite cultured skins after H&E staining. With regard to the composite cultured skin employing the ADM obtained by Method 1 as a scaffold, the epidermal keratinocytes were sufficiently overlayered, no peeling was observed between the epidermal keratinocytes and the ADM, and the attachment was good. With regard to the composite cultured skins employing the ADMs obtained by Methods 2 and 3 as a scaffold, the degree to which the epidermal keratinocytes were overlayered was slightly low, but no peeling was observed between the epidermal keratinocytes and the ADMs, and the attachment was good. With regard to the composite cultured skin employing the ADM obtained by Method 4 as a scaffold, the degree to which the epidermal keratinocytes were overlayered was slightly low, and peeling was observed between the epidermal keratinocytes and the ADM. With regard to the composite cultured skin employing the ADM obtained by Method 5 as a scaffold, the degree to which the epidermal keratinocytes were overlayered was good, but the epidermal keratinocytes had completely peeled off from the ADM. That is, in all the test areas the epidermal keratinocytes seeded on each of the ADMs were overlayered, and a stratum corneum was formed. Furthermore, with regard to evaluation of the attachment of the epidermal keratinocytes to the ADM, for the preserved basement membrane type ADMs obtained by Methods 1, 2, and 3, which employed 1 M NaCl, attachment between the ADM and the epidermal layer was confirmed in all of the test areas. In contrast thereto, with regard to the ADM obtained by Method 4 using Dispase and the ADM obtained by a trypsin treatment in Method 5, the attachment between the epidermal keratinocyte layer and the ADM was weak, peeling was observed between the epidermal layer and the ADM, and they did not attach to each other.

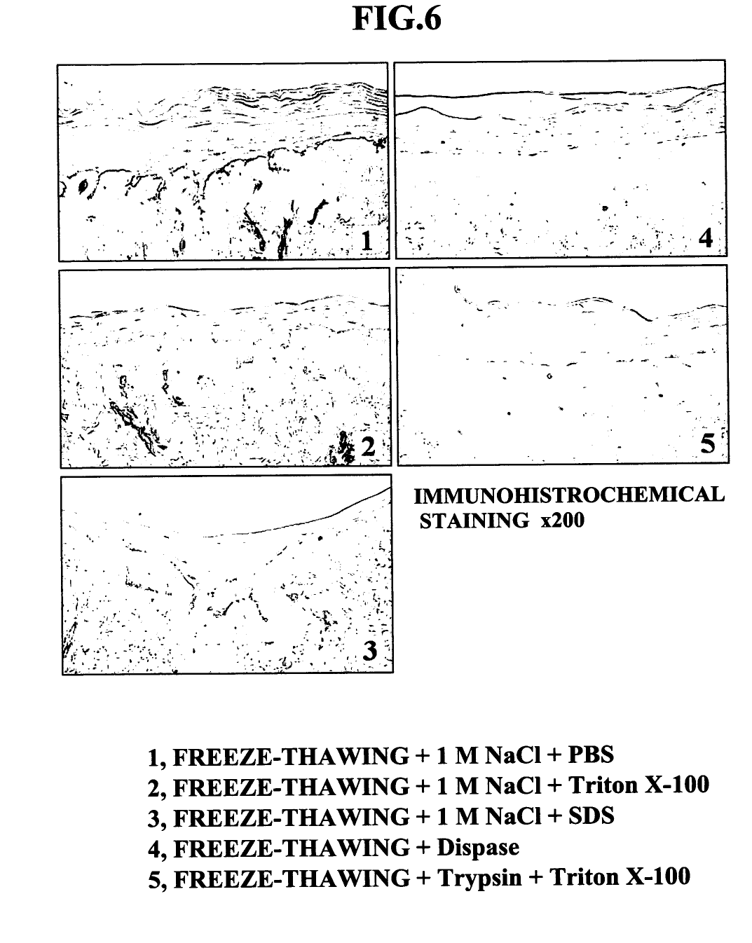

Furthermore, by immunochemically staining the composite cultured skin obtained by each of Methods 1 to 5, the presence of type IV collagen was checked. FIG. 6 shows photographs of cross sections of each of the composite cultured skins after immunochemical staining. In the composite cultured skin employing the ADM obtained by each of Methods 1 to 3 as a scaffold, staining of type IV collagen was confirmed, but in the composite cultured skin employing the ADM obtained by each of Methods 4 and 5 as a scaffold, staining of type IV collagen was not observed. That is, new construction of basement membrane structure by the epidermal keratinocytes was not observed (FIG. 6). The ADMs produced by the separation and decellularization method of the present invention exhibited excellent attachment after overlayering the epidermal keratinocytes and excellent stability as cultured tissue.

### Example 3

In accordance with FIG. 4, the composite cultured skin of the present invention and a composite cultured skin employing a conventionally developed scaffold were seeded with fibroblasts, and then with epidermal keratinocytes, and the epidermal keratinocytes were overlayered by air-liquid interface culturing for 1 week, thus giving a composite cultured skin. The animal collagen matrix referred to in Table 2 means a bovine-derived collagen gel or collagen sponge. The conventional ADM referred to here means an ADM obtained by a physical method involving freeze-thawing or a chemical method employing a protease such as trypsin or Dispase, or a detergent such as SDS or Triton X-100.

Subsequently, each composite cultured skin thus obtained was examined by H&E staining, and a comparison was made with respect to attachment after overlayering of epidermal keratinocytes and stability as a cultured tissue.

The composite cultured skin of the present invention exhibited the best attachment of the overlayered epidermal layer (Table 2). The composite cultured skin of the present invention had excellent attachment after overlayering the epidermal keratinocytes and excellent stability as a cultured tissue compared with one employing a conventional scaffold.

TABLE 2
Comparison of ADM with conventional Scaffold

| | | Attachment of | Attachment of | |
|---|---|---|---|---|
| | Basement | epidermal | overlayered | |
| | membrane | keratinocytes | epidermal layer | Overlayering |
| Artificial | − | + | + | + |
| product such | | | | |
| as Vicryl | | | | |
| Matrix of | − | ++ | ++ | + |
| animal | | | | |
| collagen | | | | |
| Conventional | − or + | − to ++ | − to ++ | + |
| ADM | | | | |
| ADM of | + | ++ | +++ | + |
| present | | | | |
| invention | | | | |

In Table 2, the judgment criteria for each evaluation item were as follows.
<Basement membrane>
+: Basement membrane remained in ADM itself.
−: No basement membrane remained.
<Attachment of epidermal keratinocytes>
++: Epidermal keratinocytes easily attached to scaffold.
+: Little attachment of epidermal keratinocytes to scaffold.
−: Epidermal keratinocytes did not attach to scaffold.
<Attachment of overlayered epidermal layer>
+++: Overlayered epidermal layer attached strongly to scaffold.
++: Overlayered epidermal layer attached to scaffold.
+: Overlayered epidermal layer attached to scaffold, but the attachment power was weak.
−: Overlayered epidermal layer did not attach to scaffold.
<Overlayering>
+: Overlayering of epidermal keratinocytes on scaffold by air-liquid interface culturing was observed.

### Example 4

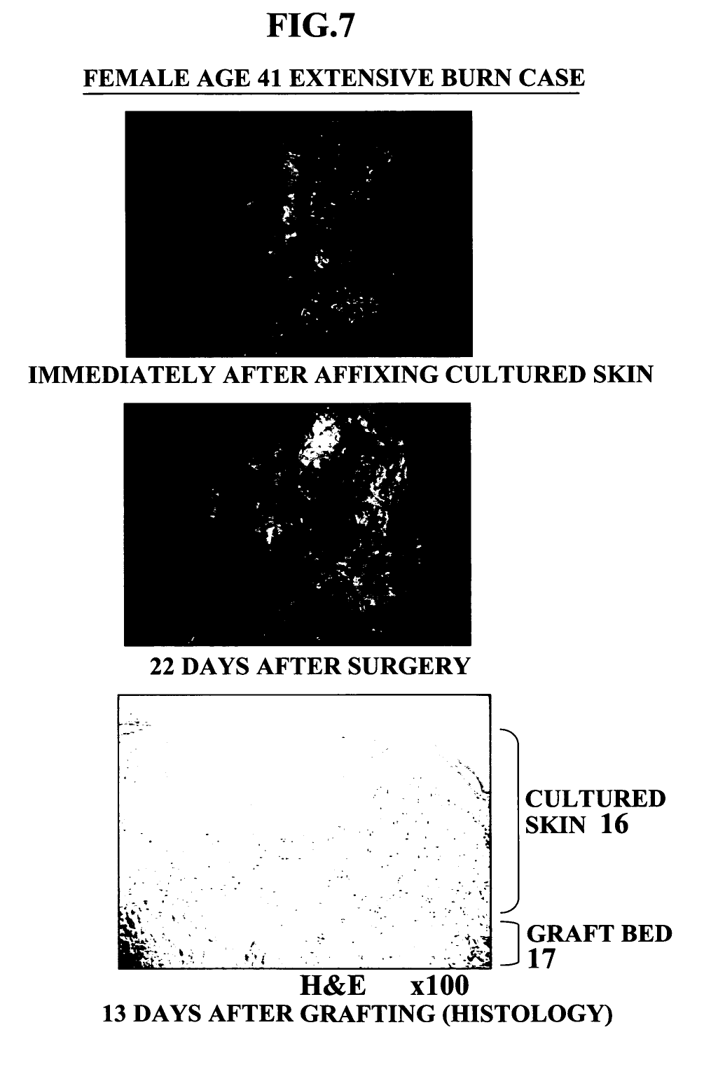

The composite cultured skin of the present invention obtained in Example 2 was washed with HBSS (Hanks' Balanced Salt Solution) three times and then grafted within 1 hour onto an affected part, that is, a part of a wound of a severe bum case. The number of grafts was four, each thereof being 5×5 cm. The grafting method involved taking cultured skin out of a petri dish aseptically with tweezers, and grafting it with the epidermal side facing upward. When viewed 22 days after the grafting, the cultured skin had survived completely, and an epidermis had formed (FIG. 7). In an H&E stained image of the cultured skin 13 days after the grafting, attachment between the graft bed and the cultured skin was good, new blood vessels had formed within the cultured skin dermis, and the epidermal keratinocytes had a morphology that was almost the same as that of normal skin tissue.

### Example 5

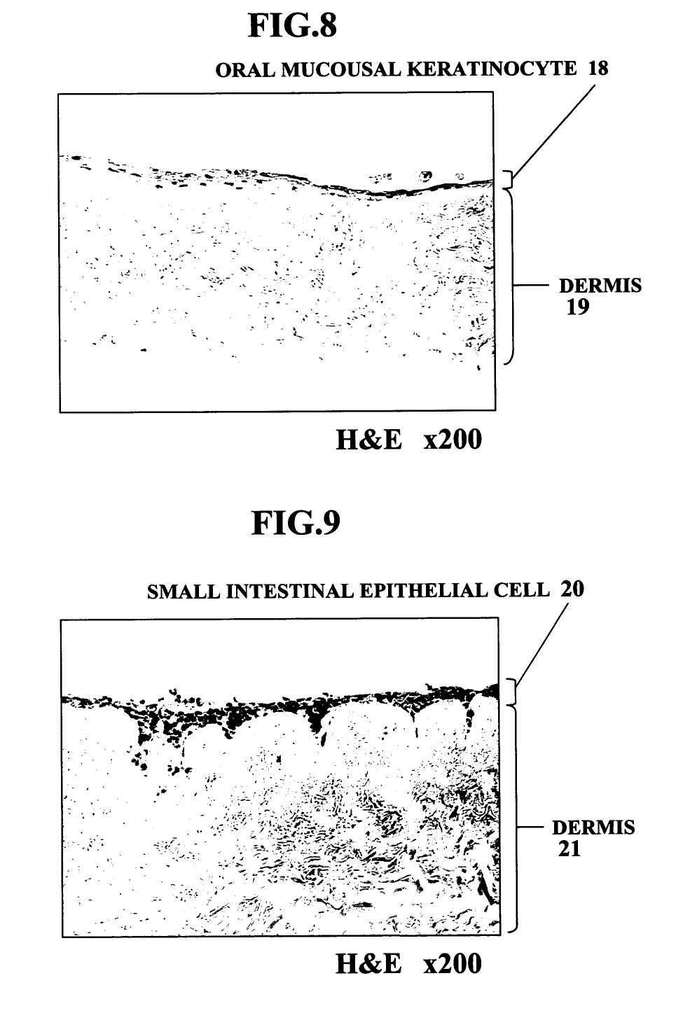

Cultured tissue into which cultured oral mucousal keratinocytes or cultured small intestinal epithelial cells were incorporated was obtained by air-liquid interface culturing for 1 week using the acellular dermal matrix of the present invention obtained in Example 1 as a scaffold, without using fibroblasts. The cultured tissue thus obtained was examined by H&E staining. FIG. 8 shows a photograph of a cross section of the cultured oral mucousa tissue, in which the oral mucousal keratinocytes are attaching to the ADM and are overlayered thereon. FIG. 9 is a photograph of a cross section of the cultured small intestinal equivalent tissue, in which the small intestinal epithelial cells are attaching to the ADM and are overlayered thereon. Both the cultured oral mucous tissue and the cultured small intestinal tissue exhibited good attachment, and the ADMs were usable as a scaffold for various types of cells.

### Example 6

With regard to the acellular dermal matrix of the present invention, an example in which porcine skin was used as a starting material is illustrated below.

Skin harvested from a pig (split-thickness skin: average thickness about 0.38 mm: 0.015 inch thick) was frozen using liquid nitrogen (at a temperature of −80° C. for 24 hours, and subsequently at a temperature of −196° C. for 48 hours), and thawed (at a temperature of 37° C. for 5 minutes), then immersed in 1 M NaCl, and incubated at 37° C. for 12 hours. The treatment allowed the epidermis and the dermis to be easily separated in a state in which the basement membrane remained in the dermis.

The dermal portion thus obtained was continuously washed using a TransWell with PBS (37° C.) for 1 week. This treatment allowed all the cellular components (cutaneous appendage cells, vascular cells, fibroblasts, nervous system cells, others) within the dermis to be removed, thus converting the dermis into a dermal matrix in which the basement membrane was preserved and which contained mainly collagen.

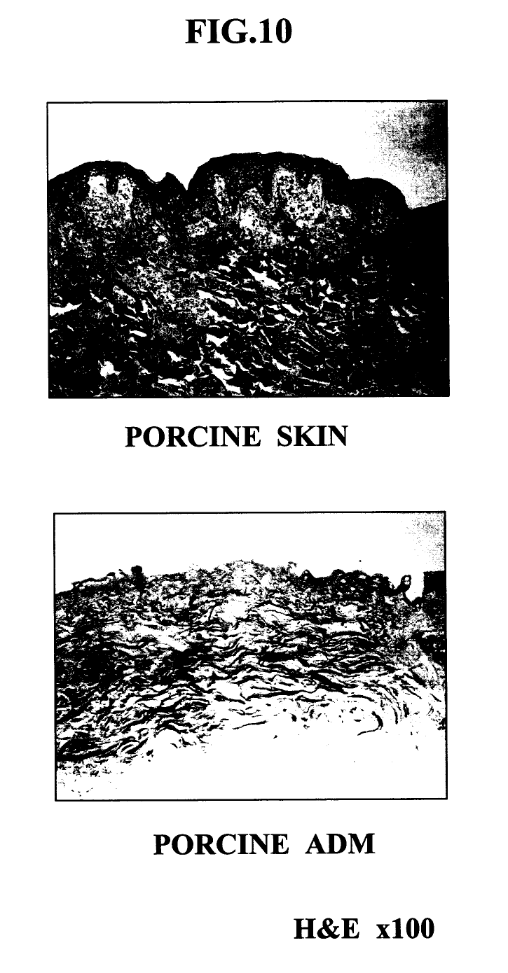

The properties of the ADM obtained as above were examined. FIG. 10 shows photographs of a cross section of the porcine skin after H&E staining and a cross section of the porcine ADM. In the photograph of the cross section of the porcine skin, portions stained bluish-purple correspond to epidermal keratinocytes or dermal fibroblast nuclei. The presence of an epidermal layer and dermal fibroblasts was confirmed in the porcine skin. On the other hand, in the porcine ADM, it was confirmed that the epidermal layer had peeled off, and dermal fibroblasts were removed. That is, the ADM thus obtained was completely acellular (FIG. 10).

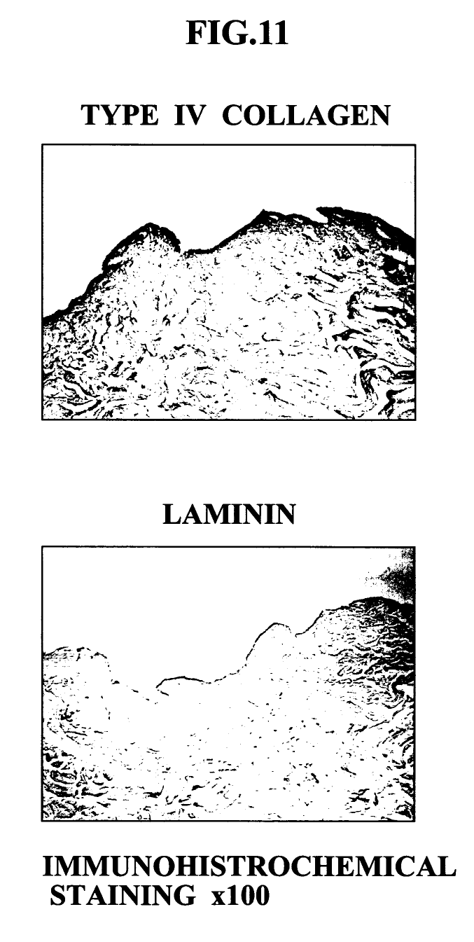

The degree to which the basement membrane was preserved was checked by immunochemically staining type IV collagen and laminin, which are basement membrane components. FIG. 11 shows photographs of cross sections of the porcine ADM after immunochemical staining, brown-stained portions corresponding to type IV collagen or laminin. In FIG. 11, portions strongly stained with brown were observed in the porcine ADM, and it was confirmed that the basement membrane was preserved (FIG. 11).

### Example 7

In accordance with FIG. 4, the porcine ADM of the present invention was seeded with human fibroblasts, and then with human epidermal keratinocytes, and the epidermal keratinocytes were overlayered by air-liquid interface culturing for 1 week, thus giving a composite cultured skin. The epidermal keratinocytes were sufficiently overlayered, and attachment to the ADM was good.

### Example 8

The composite cultured skin employing the porcine ADM of the present invention can be used as a graft for a wound of a severe bum case after washing with HBSS (Hanks' Balanced Salt Solution), etc. The grafting method may involve taking cultured skin out of a petri dish aseptically with tweezers, and grafting it onto the affected part with the epidermal side facing upward.

### Example 9

Cultured tissue into which human cultured oral mucousal keratinocytes or human cultured small intestinal epithelial cells were incorporated was obtained by air-liquid interface culturing for 1 week using the acellular dermal matrix of the present invention as a scaffold, without using fibroblasts. Both the oral mucousal keratinocytes and the small intestinal epithelial cells attached to the ADM and were overlayered thereon. The porcine ADM was usable as a scaffold for various types of cells.

1-7. (canceled)

8. A skin separation and decellularization method comprising a step of freeze thawing harvested skin and then separating the skin into epidermis and dermis by a treatment with hypertonic saline, and a step of washing the separated dermis.

9. An acellular dermal matrix that has been separated and decellularized by a step of freeze thawing harvested skin and then separating the skin into epidermis and dermis by a treatment with hypertonic saline, and a step of washing the separated dermis.

10. A method for producing an acellular dermal matrix, the method comprising a step of freeze thawing harvested skin and then separating the skin into epidermis and dermis by a treatment with hypertonic saline, and a step of washing the separated dermis.

11. The acellular dermal matrix according to claim 9, wherein human skin is used as a starting material.

12. The acellular dermal matrix according to claim 9, wherein porcine skin is used as a starting material.

13. A composite cultured skin comprising the acellular dermal matrix according to claim 9 as a scaffold.

14. A composite cultured epithelium comprising the acellular dermal matrix according to claim 9 as a scaffold.
